(19) United States
(12) Patent Application Publication
(10) Pub. No.: US 2002/0065673 A1
(43) Pub. Date: May 30, 2002

(54) Business intelligence system

(76) Inventor: William Armstrong Rooke, Enmore (AU)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/844,250

(22) Filed: Apr. 27, 2001

(30) Foreign Application Priority Data
Apr. 28, 2000 (AU) 30202/00

(51) Int. Cl. G06F 17/60

(52) U.S. Cl. 705/1

(57) ABSTRACT

The present invention relates to business intelligence systems. An enterprise's business intelligence may be embodied in business intelligence artefacts such as reports, queries, analytical documents, spreadsheets, etc. Over time, many of these documents are produced. The same artefacts may be produced by different departments in an enterprise. This is an inefficient use of resources. Further, when a user is producing an artefact, they add their own knowledge to the artefact (in the form of table names, column names, etc, that they have selected themselves using their business knowledge). This knowledge is not accessible.

The present invention provides a system and method which enables this knowledge to be accessed, by analysing the artefacts which are produced by an enterprise and producing metadata which can be queried to access the knowledge locked up in the artefacts.

### FIELD OF THE INVENTION

The present invention relates to business intelligence systems.

### BACKGROUND OF THE INVENTION

Enterprises implement Business Intelligence (BI) technology to improve access to the enterprise's data sources in order to, for example, create summaries, presentations, look for trends, patterns, associations, provide aggregations, and apply multi-dimensional analysis, among other things. Sophisticated BI products such as Brio™, Cognos™ and others allow enterprises to have access to all data stored in all of the enterprises database packages, (e.g. accounts package, stock control database package, sales database, etc) in order to draw on all the available data across the enterprise. These types of sophisticated BI systems, therefore, attempt to make all the enterprises data available for the production of meaningful information by users to enable an enterprise to improve its efficiency.

Nevertheless, although Business Intelligence systems are a great improvement and do allow users to present intelligent information, drawn from a firm's entire database, in easily digestible format, they go no further than this. What tends to occur over time is that many users across an enterprise utilising a BI system produce many reports, queries, analytical documents, spreadsheets, presentations and other products enabled by the BI system so that, after a while, there may be many thousands of such BI artefacts available. These artefacts essentially embody an enterprise's “knowledge”, which can be considered as a combination of the data that the enterprise has available and the information added by the user of the BI tool to produce artefacts (i.e. the user's knowledge). This knowledge is not readily accessible. It is locked away in what may be thousands of BI artefacts.

For example, if a user of a BI system produces a report from the firm's database utilising the BI tools, in order to make that report meaningful, they may need to add information or change information. They may have to provide meaningful list names for a report, for example, “birthdays”, “expiry dates”, “transaction dates”, etc. Titles of the data as stored in the database may be fairly meaningless (usually they are technical terms which have been chosen by an enterprises IT department, and they can be quite cryptic). Users, therefore, effectively add their own knowledge to the firm's data when they utilise the BI system. This knowledge remains “locked up” in the particular BI axtefact which has been produced. Because many users are using the BI system, much knowledge becomes locked up in these disparate fragments.

Users have no proper access to this knowledge. This often results in repetition. Two or more users may design a very similar BI artefact because they will not be aware that the same or similar artefact has in fact been prepared before. Users from different departments of an enterprise may design a report which effectively uses the same data, but which include different titles, because the users perspectives are different. In other words, many users may be accessing the same data for the same ends, but this cannot be ascertained from the end appearance of the BI artefacts.

There are often in BI enabled enterprises many analysts applying their own knowledge and adding meaning to raw data that they are analysing and presenting to their superiors for business decisions. A problem emerges that there is now no authoritative source of this knowledge. Effort is duplicated, time is wasted, information may be mis-categorised, conflicting results generated, opportunities are missed and wrong decisions may be made.

Businesses attempt to at least partly address this problem by implementing solutions such as building data dictionaries, reviewing and renaming columns and tables in an enterprises databases for consistency and to reflect the user's perspective. Such solutions are very expensive and are often not completed because of the difficulty and expense in implementing them. They usually require IT experts to work from the “bottom-up” analysing the firm's available data and trying to make sense of it, consulting with firm's management, and then implementing changes. The metadata created often bears no relation to the actual use of the data in the enterprise, because no one implementing the solution really knows how the data is used across the organisation. Such projects often grind to an expensive halt, well before completion.

Another problem relates to the effect of making a change to the enterprise's IT systems (e.g. an upgrade of hardware or software, legislative changes requiring a change to the IT systems).

Which BI artefacts are going to be affected by the changes? Which departments using the BI artefacts are going to be affected by the changes? Which BI artefacts need to be addressed in order to make allowance for the changes? Finding out which BI artefacts are affected and implementing changes is a very difficult time-consuming and expensive task.

Further, in enterprises which implement BI systems successfully, increased use of the system eventually leads to capacity problems. To address overuse, a firm may decide to add more mission critical hardware. This is the simplest solution, but it is an expensive one and only addresses a single bottleneck. Further, if an analysis were made of system usage, it would in all likelihood be found that the systems are not being used efficiently. In many cases addition of more expensive hardware would be avoidable by optimising use of the systems. Optimisation can include such items as reducing or eliminating redundant documents and adding data mart and cubes. This is a further time-consuming process (and therefore also expensive), particularly when there may be many BI artefacts to analyse. The simplest solution, therefore, is often just to add more hardware, when the more effective solution would in fact be to rationalise and optimise the system.

### SUMMARY OF THE INVENTION

The present invention provides a method of obtaining knowledge about an enterprise's data, comprising the steps of analysing business intelligence artefacts produced by users of an enterprise's business intelligence system, producing metadata based on the analysis, and making the metadata available to provide information about the enterprise's data.

Preferably, the metadata is made available to users so that they can query the data to find out information about the enterprise's data. Preferably, business users are able to make optimal use of their business intelligence system and technical users so that they can manage the business intelligence system better.

Business Intelligence artefacts include any artefacts of an enterprise produced from data available to the enterprise in order to provide meaningful information to the enterprise, and it includes any query, analytical document, chart, spreadsheet, presentation, and more.

Preferably, Business Intelligence artefacts are also produced by a Business Intelligence system, but the present invention is not limited to BI artefacts in the narrow sense of the term (where a BI system is implemented). Business Intelligence artifacts are produced by enterprises which do not have BI systems, and the present invention may be applied in enterprises which do not have such systems.

Preferably, the Business Intelligence artefacts are in electronic form.

Preferably, the artefacts have some structure to them. That is, they may have columns with titles or tables with titles. They are preferably not unstructured documents such as word processing systems documents which merely contain only unstructured text.

In the present invention, therefore, Business Intelligence artefacts, such as reports, documents, analyses, presentations, which are produced by the users of a Business Intelligence system (or produced by an enterprise which does not operate a BI system) are analysed to produce metadata (knowledge about Business Intelligence artefacts), and this metadata is made available for users to query to provide information. Essentially, this enables access to the “knowledge” of the enterprise embodied in the Business Intelligence artefacts. The metadata is preferably made available in a structured and therefore queryable form. Rather than working from the “bottom-up” from the enterprise's database (as present attempts to overcome this problem do), the system of the present invention accesses the knowledge of the users of the BI system and provides data about that as well as about the data stored in the enterprise's database.

Preferably, the step of analysing the business intelligence artefacts comprises, for each artefact, the step of determining attributes of the artefact according to a list of attributes. Preferably, the list of attributes is commonly applied to each of the artefacts. Preferably, each artefact is analysed in accordance with an attribute template. Preferably, the application of the common template provides a frame of reference to enable functions such as a matching function, to determine similarity of artefacts, preferably based on the artefacts characteristics.

Preferably, the method includes the step of preparing and storing attribute data relating to the attributes of the artefacts, which have been determined by the analysis process.

The attribute data may include attribute structure and attribute values (where the values imply business rules).

The attribute data preferably includes data on operational characteristics of the artefact. For example, the data may include the identity of the person that formulated the artefact, the identity of the user of the artefact, the time that the artefact was used, the time it took to produce results from the use of the artefact and the number of results which were produced by use of the artefact. When such characteristics are stored for all the artefacts in an enterprise queries can be implemented such as “which artefacts does user X use”? “Which artefacts take up a lot of system time?” “Which artefacts take up a lot of system space?”

Other characteristics of the artefacts may also be included in the attribute data. For example, the attribute data may also include information on the type of analysis applied by the artefact and data on the information within the scope of the artefact, Such data items can be used to locate artefacts which, for example, relate to the same subject matter.

Preferably, the attribute data includes database data including information identifying database tables accessed by application of the artefact. This enables identification of the parts of the enterprises' database utilised by particular artefacts. This information can be applied to rationalise a company's IT systems and also to assist in steering a process of upgrading or changing a company's IT system (the system can preferably identify which artefacts are likely to be affected by the upgrade or change).

Preferably, the attribute data includes business item data, which includes information on any business item associated with an artefact. Users of a BI system add meaning to their artefacts by for example, renaming database columns into business terms. Or they may create virtual columns by defining formulae that optionally use real database columns. Preferably the present invention identifies and stores this business item data, so that, for example, searches of the, artefacts can be implemented utilising business terms or business rules that are formulae.

Business item data may include table names, column names, renamed items, titles, access names, among others.

The method of the present invention also preferably includes the step of querying the metadata. The metadata may be queried to determine a match between artefact attribute data input by a user and attribute data associated with any stored artefacts. The match query may determine the degree of the match. This can enable the user to, for example, find any similar or same artefacts in the enterprise.

As discussed above, the step of querying the metadata may also enable a determination of how much of an enterprise's database is utilised by a particular artefact and what parts of the enterprise's database are utilised by a particular artefact.

Often, when analysts are utilising BI systems they may wish to add annotations to their observations on a particular artefact or artefacts e.g. an observation on a particular inconsistency in data. The method of the present invention preferably includes the step of allowing users to annotate the stored metadata with observations relating to the artefacts. This effectively becomes “new” knowledge which was not originally part of the Business Intelligence pool, but which is elicited from users of the system and stored with the metadata associated with the artefact.

The present invention further provides a system for obtaining knowledge about an, enterprise's data, comprising a harvester means for analysing business intelligence artefacts produced by users of an enterprise's business intelligence system and producing metadata based on that analysis.

Preferably the system of this aspect of the invention may include means for applying any or all of the method or steps discussed above.

### DESCRIPTION OF PREFERRED EMBODIMENT

Features and advantages of the present invention will become apparent from the following description of an embodiment thereof, by way of example only, with reference to the accompanying drawings, in which:

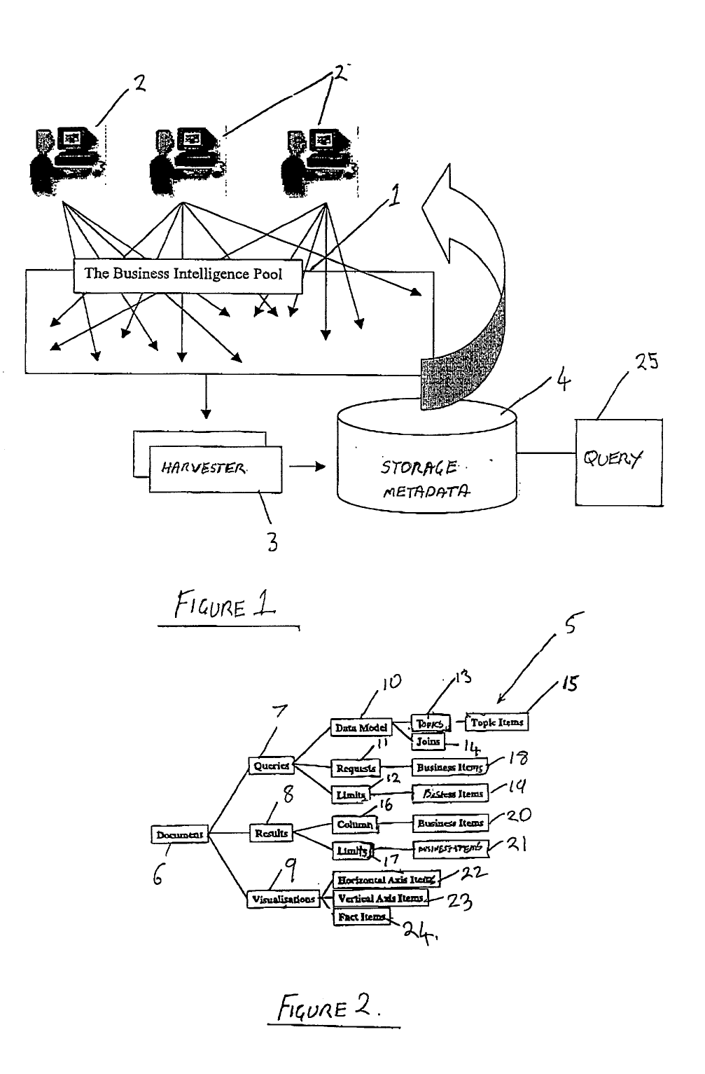

FIG. 1 is a schematic diagram illustrating a system in accordance with an embodiment of the present invention;

FIG. 2 is an attribute template employed by the embodiment of FIG. 1;

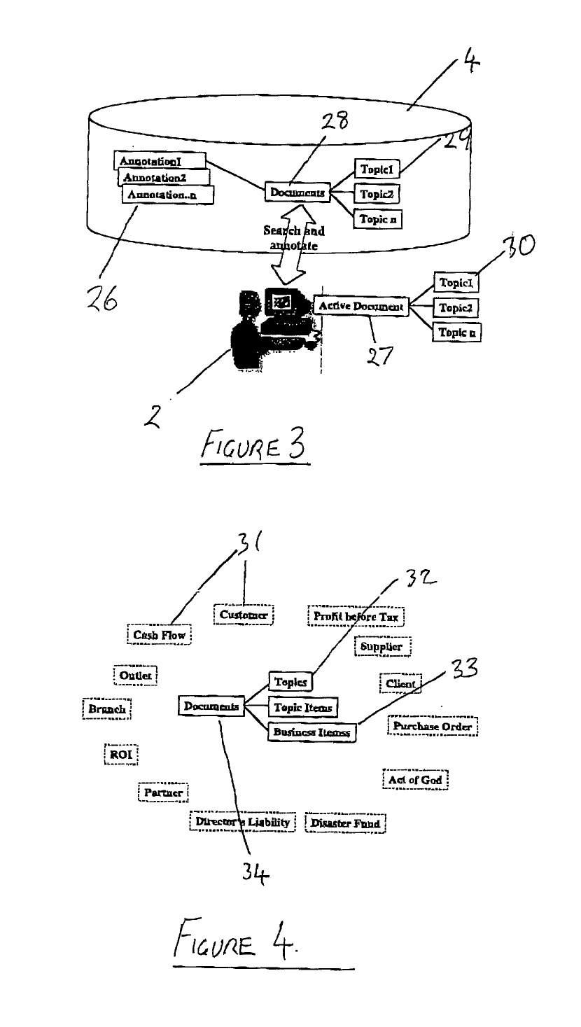

FIG. 3 is an illustration representing an annotation process utilising the system of FIG. 1;

FIG. 4 is a diagram illustrating how example business items may be utilised with the system of FIG. 1; and

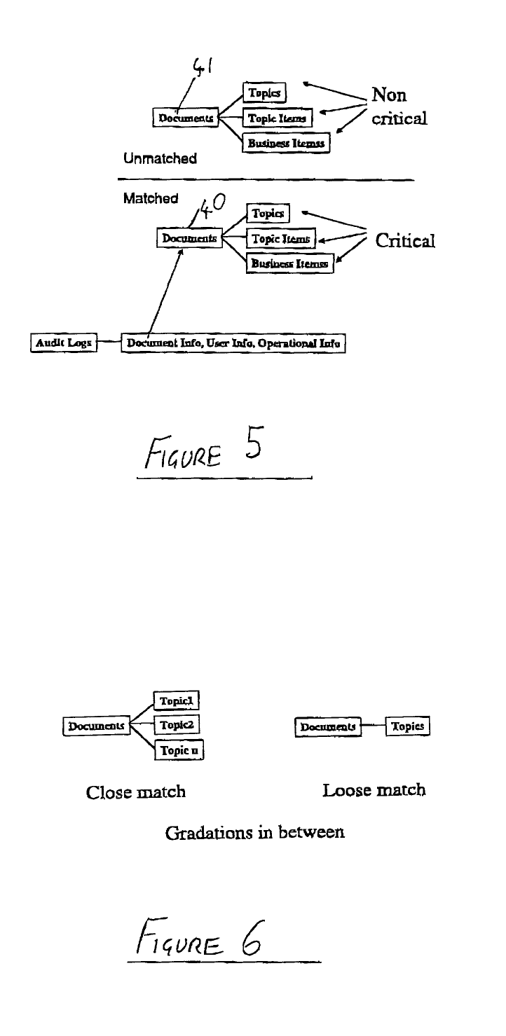

FIGS. 5 and 6 are diagrams illustrating matching of artefacts utilising the system of FIG. 1.

Referring to FIG. 1, the block designated by reference numeral 1 represents a “pool” of business intelligence artefacts produced by users 2 in an enterprise (which may be any company or organisation). In this embodiment the users 2 are utilising a Business Intelligence system having access to data across the enterprises available databases (a major advantage of most sophisticated BI systems). The Business Intelligence Pool 1 includes all business intelligence artefacts, in this embodiment stored in electronic form, produced by the users 2 and includes queries, electronic documents, spreadsheets, presentations, among others. The users 2 are constantly using artefacts to run reports etc. They are also generating new artefacts to run different reports, analyses, presentations, etc. Particularly in a large enterprise, many users may be separately generating artefacts that carry out similar processes to obtain similar results. Although the artefacts are similar, however, they will not generally be exactly the same because they have been developed utilising a particular user's knowledge, and from each particular user's (usually different) perspective. For example, a user may add different business items (title, column names, etc) to a report which accesses a similar part of the firm's database and is essentially performing the same function as other, similar artefacts. The business intelligence pool 1, after a while of operating a BI system, may contain many thousands of documents, at least some of which may perform some of the same tasks, some with conflicting results.

The system of this embodiment accesses the knowledge stored in the BI pool, gives it structure and stores it in a storage depot where it can be accessed to provide information about the knowledge embodied in the BI pool 1.

The harvester 3 includes appropriate software (which is able to be implemented by the skilled person from the following detailed description) which is arranged to analyse the business intelligence artefacts from the business intelligence pool 1 and produce metadata (data about data or knowledge about data), which in this embodiment is stored in storage depot 4. A query means 25 enables users 2 to have access to the stored metadata to provide knowledge of actual use of business intelligence data artefact.

Referring to FIG. 2, in order to analyse each artefact, the harvester 3 applies a list of attributes in the form of an attribute template 5, and determines which of these attributes each particular business intelligence artefact includes, determines their values and stores the resulting metadata in storage depot 4.

As illustrated in FIG. 2, the template includes a list and structure of attributes at least some of which will be possessed by each business intelligence artefact. Each business intelligence artefact will usually be in the form of a document 6, which may include queries 7, results 8 and visualisations 9. Queries 7 include such things as questions the artefact is asking of the enterprise's data. Results 8 include the results of the artefacts operation on the data and visualisations 9 include any graphical or tabular contents of the artefacts. Note that not all artefacts in the business intelligence pool 1 will include all of these attributes, e.g. some documents may not include visualisations 9. Each query 7 can be broken down into a data model attribute 10, request attribute 11 and limits attribute 12. The data model attribute 10 includes information on what parts of the database are accessed by the query, e.g. what tables in the database are accessed and what relationships need to exist between their members. Requests 11 include information on what questions are being asked, i.e. what information does the user require from the artefact. The limits 12 include any limits which are placed on the query e.g. limits of time and date, or geographical limits (e.g. North America only).

The data model 10 is broken into topics 13 (which business topic does the data model 10 cover) and joins 14 (the relationships between topics used). The template further breaks the topics 13 down into topic items 15. Topic items 15 are such things as labels and titles which are used in the enterprise's database, as opposed to business items which are labels and titles which have been chosen by users to provide meaning (e.g. in the presentation of business information—see later).

The results attributes 8 are broken down into columns 16 and limits 17. Columns 16 include such things as the S results in a column in a presentation, for example and the limits 17 have the same definition as discussed above in relation to limits 12. Business items 18, 19, 20, 21 are obtained from the analysis of the requests 11, limits 12, columns 16 and limits 17. These business items include such things as titles, column names, etc which may have been added by the user to the artefact, during development of the artefact.

Visualisations 9 include graphs and can be broken down into such items as horizontal axis items 22, vertical axis items 23 and fact items 24. Business items may be extracted from these as well (not shown).

The template illustrated in FIG. 2 is a schematic example only. Generally, the template is nothing more than a set of predetermined criteria according to which each of the artefacts are evaluated and may include far more attributes than are shown in FIG. 2. The harvester 3 includes means arranged to evaluate each artefact according to the predetermined criteria, and this may be by way of grammatical analysis utilised parsing techniques, lexical analysis, etc. Different harvesters are designed for different types of BI systems and may be designed for different types of databases and different types of businesses.

A number of harvesters 3, 3A may be utilised for harvesting from different areas of an enterprise's business intelligence pool. A number of harvesters may be used in parallel in order to make the most efficient use of the systems available.

In this preferred embodiment, as well as the attributes which are illustrated in FIG. 2, the following attribute data is also produced for each artefact

1. Data on operational characteristics of the artefact, including the identity of the user of the artefact, the time the artefact was used, the time it took to produce results from the use of the artefact, and the number of results which were produced by use of the artefact.

2. Data on the type of analysis applied by the artefact and the information within the scope of the artefact.

Further, audit data associated with the business intelligence system can determine who is using what artefact, how many times the artefact has been used and for how long.

The system also comprises a query means 25. This includes appropriate software enabling users 2 to query the stored metadata (in storage depot 4) to access the knowledge of the enterprise. The query means includes appropriate software enabling access to all the attribute data discussed above, and it will be appreciated that a skilled person is able to devise appropriate software to carry out this task.

In addition the system enables further information to be obtained from users of the system in the form of annotations. This facility enables the information stored in the storage depot 4 to be augmented by actual “hands on” knowledge from the users themselves, so that the storage depot 4 not only includes implicit knowledge from the BI pool, but also explicit knowledge from the users.

The query means 25 enables a number of queries, as discussed above, including the following important types of query activity.

1. FIG. 3 illustrates a process whereby a user 2 of the system can add extra knowledge to the storage depot 4 by way of adding annotations 26 to the existing metadata

For example, a user 2 working on an active document 27 from the BI pool 1 may come across something unusual in the active document that requires an explanation, or may wish to add an observation to the active document about a process the user 2 undertook in preparing the active document (these are examples only, the user may wish to add knowledge to the document for many other reasons). With the present system, this can be done by way of adding an annotation 26, which is a “parcel” of information which will be associated with the document when the document is accessed by a future query. In addition, as the system enables a query, utilising the metadata, to find similar documents 28 to the active document 27, which include similar topics 29, for example, to the topics 30 that the active document 27 is concerned with. Subsequently, the system enables a user 2 to include the annotation data 26 with all these similar documents. This enables searches by annotation subject matter, to locate documents which are similarly annotated, for example.

It also enables searching for similar artefacts (artefacts which have a similar structure, for example) to see whether any annotations are included with similar documents. For example, the user may find, from a revenue chart, that there has been an increase in revenue in a particular month. On carrying out a search for documents that may have a similar “blip” in a plot, the user may come across a trucking chart and find that there is a similar blip and an annotation associated with the chart which provides explanation as to why the blip occurred, which can possibly be associated with the blip in revenue as well.

2. Queries can utilise business item data to locate artefacts which are concerned with a particular business item selected by a user. This is illustrated by FIG. 4. One or more business items 31 may be compared with business item 32, 33 attributes of an artefact to locate artefacts 34 which are concerned with the particular business item.

3. It is also possible to carry out a query to see whether a document is “matched” by a predetermined query document (e.g. where a user wishes to locate a document similar to one they are already working on). Matching is carried out by comparing attribute data of artefacts. A determination can be made as to whether the artefacts match closely or loosely, as well as gradations in between (FIG. 6).

4. From time to time it may become necessary for an enterprise to amend their system in some way. For example, business rules may change, legislation may decide that they must operate in a different way, they need to improve performance or there is a new technology which needs to be integrated within the enterprise's systems. Any such change to an enterprise's systems is likely to affect the business intelligence artefacts which are presently produced by the systems. The identification of the parts of the business intelligence system which are likely to be affected by the systems changes, so that changes can be made to those business intelligence artefacts that are affected, is a long and laborious (and very expensive process). The system of the present invention enables queries to be made to facilitate the process of identification of the affected artefacts and also enables rationalisation of the system. Referring to FIG. 5, utilising audit logs and the metadata provided by the present system, a query can be made to find out which business intelligence documents 40 are used the most, and which documents 41 are used the least, and gradations in between. The most critical documents to the enterprises system can therefore be identified, and the business items that they relate to can also be identified. The IT department therefore knows which aspects of the DI system to concentrate on when considering the effect of implementation of changes to the enterprise's systems.

Further, because the metadata includes attribute data on the areas of the enterprises database which are utilised by each artefact, how much they are utilised, etc., the critical areas of the database can be identified, and priority can be given to Implementing the changes in those areas.

Any systems changes, therefore, can be implemented in a much less time consuming and expensive manner than usual.

5. Further, the system of the present invention also assists rationalization of an enterprise's systems. Documents which are not being used can be dispensed with, and the present system enables identification of such documents. If an enterprise's systems are becoming slow because of overuse, for example, a usual fix is to add more hardware. Analysis of the systems via the system of the present invention may dispense with the need to add more hardware by optimising the system, by providing a usage characteristic which cuts the cost by adding data marts and cubes, for example.

Variations and/or modifications may be made to the invention as shown in the specific embodiments without departing from the spirit or scope of the invention as broadly described. The present embodiments are, therefore, to be considered in all respects as illustrated and not restrictive.

The claims defining the invention are as follows:

1. A method of obtaining knowledge about an enterprises data, comprising the steps of analysing business intelligence artefacts produced by users of an enterprises business intelligence system, producing metadata based on the analysis, and making the metadata available for access by users to query to provide information about the enterprises data.

2. A method in accordance with claim 1, wherein the step of analysing the business intelligence artefacts comprises, for each artefact, the steps of determining attributes of the artefact according to a list of attributes.

3. A method in accordance with claim 2, wherein the list of attributes is a commonly applied list of attributes.

4. A method in accordance with claim 2, wherein the step of producing metadata comprises, for each artefact, the step of preparing and storing attribute data on the attributes of the artefact determined by the analysis process.

5. A method in accordance with claim 4, wherein the attribute data includes information on the attribute structure.

6. A method in accordance with claim 4, wherein the attribute data includes information on the attribute values.

7. A method in accordance with claim 4, wherein the attribute data includes information on operational characteristics of the artefact.

8. A method in accordance with claim 7, wherein the operational characteristics include one or more of the identity of the user of the artefact, the time the artefact was used, the time it took to produce results from the use of the artefact, and the number of results which were produced by use of the artefact.

9. A method in accordance with claim 4, wherein the attribute data includes information on one or more of the type of analysis applied, and the information within the scope of the artefact.

10. A method in accordance with claim 4, wherein the attribute data includes database data including information on any database tables accessed by application of the artefact.

11. A method in accordance with claim 4, wherein the attribute data includes business item data including information on any business items associated with the artefact.

12. A method in accordance with claim 11, wherein the business item data includes one or more of the following table names; column names, renamed items; titles; axis names.

13. A method in accordance with claim 1, further comprising the step of querying the metadata.

14. A method in accordance with claim 13, wherein the step of querying the metadata comprises the step of determining whether a query artefact attribute data is matched by attribute data associated with any artefact.

15. A method in accordance with claim 14, wherein the step of determining the match includes the step of determining the degree of the match.

16. A method in accordance with claim 13, wherein the step of querying the metadata comprises the step of determining the degree of usage of the enterprise's database by an artefact.

17. A method in accordance with claim 13, wherein the step of querying the metadata comprises the step of determining who is using or has used an artefact.

18. A method in accordance with claim 13, wherein the step of querying the metadata comprises the step of determining the area of usage of the enterprise's database by an artefact.

19. A method in accordance with claim 13, wherein the step of querying the metadata comprises the step of querying the attribute data for business items.

20. A method in accordance with claim 1, wherein the metadata includes user annotation information relating to the business intelligence artefacts.

21. A method in accordance with claim 1, wherein a business intelligence artefact includes one or more of: queries; analytical documents; spreadsheets; presentations.

22. A system for obtaining knowledge about an enterprise's data, comprising a harvester means for analysing business intelligence artefacts produced by users of an enterprise's business intelligence system and producing metadata based on the analysis.

23. A system in accordance with claim 22, wherein the harvester means is arranged to analyse the business intelligence artefacts by determining attributes of the artefact by applying a list of attributes to the artefact.

24. A system in accordance with claim 23, wherein the list of attributes is a common list of attributes.

25. A system in accordance with claim 23, wherein the harvester means is arranged to produce attribute data from the analysis of the attributes of the artefact.

26. A system in accordance with claim 25, wherein the attribute data includes information on the attribute structure.

27. A system in accordance with claim 25, wherein the attribute data includes information on the attribute values.

28. A system in accordance with claim 25, wherein the attribute data includes data on operational characteristics of the artefact.

29. A system in accordance with claim 28, wherein the operational characteristics include one or more of the following: the identity of the user of artefact; the time that the artefact was used; the time it took to produce results from the use of the artefact; and the number of results which were produced by use of the artefact.

30. A system in accordance with claim 25, wherein the attribute data includes one or more of the type of analysis applied by the artefact and the information within the scope of the artefact.

31. A system in accordance with claim 25, wherein the attribute data includes database data including information on any database tables accessed by application of the artefact.

32. A system in accordance with claim 25, wherein the attribute data includes database data including information on any database tables accessed by application of the artefact.

33. A system in accordance with claim 32, the business item data includes one or more of the following: table names; column names; renamed items; titles; and axis names.

34. A system in accordance with claim 22, further comprising a query means arranged to enable querying of the metadata.

35. A system in accordance with claim 34, wherein the query means includes matching means, arranged to determine whether a query artefact attribute data is matched by attribute data associated with any artefact.

36. A system in accordance with claim 35, wherein the matching means is arranged to determine the degree of match.

37. A system in accordance with claim 34, wherein the query means includes usage determination means arranged to determine the degree of usage of the enterprise's database by an artefact.

38. A system in accordance with claim 33, wherein the query means includes user identification means arranged to identify who is using or has used an artefact.

39. A system in accordance with claim 33, wherein the query means further comprises!database area determination means for determining the area of usage of the enterprise's database by an artefact.

40. A system in accordance with claim 33, wherein the query means is arranged to query the attribute data with business item data to locate artefacts including queried business items.

41. A system in accordance with claim 22, further including annotation means arranged to enable users to annotate information relating to the business intelligence artefacts, to the metadata.
